(19) United States
(12) Patent Application Publication
(10) Pub. No.: US 2018/0253634 A1
(43) Pub. Date: Sep. 6, 2018

(54) SECURITY PROTECTED PASSIVE RFID DEVICE

(71) Applicant: ZWIPE AS, Oslo (NO)

(72) Inventors: Sarah FORTASSIN, Paris (FR); Peter Robert LOWE, Peyton, CO (US)

(21) Appl. No.: 15/749,836

(22) PCT Filed: Aug. 5, 2016
(86) PCT No.: PCT/EP2016/068804

§ 371 Date: Feb. 2, 2018

Related U.S. Application Data
(60) Provisional application No. 62/202,188, filed on Aug. 7, 2015.

(30) Foreign Application Priority Data
Aug. 28, 2015 (GB) 1515358.8

(51) Int. Cl. G06K 19/077; G06F 21/32; G06K 7/10

(52) U.S. Cl. CPC G06K 19/07773; G06K 7/10366; G06F 21/32

(57) ABSTRACT

An RFID device includes an antenna, a passive RFID communication module and a passive biometric authentication module. The passive RFID communication module is configured to transmit data to an RFID reader without the use of encryption where, the RFID device is configured such that initially power is supplied only to the passive biometric authentication module until the biometric authentication module 120 has verified the identity of a user, whereupon power is supplied to the passive RFID communication module 110 to permit communication, thus the RFID device is thus less vulnerable to sniffing attacks than conventional unencrypted RFID tags because the device will hold its data securely until an authorized biometric identifier is presented to it.

### TECHNICAL FIELD

The present invention relates to a security protected passive radio frequency identification (RFID) device.

### BACKGROUND

FIG. 1 shows the architecture of a conventional passive RFID device 2. A powered RFID reader 4 transmits a signal via an antenna 6. The signal is typically 13.56 MHz for MIFARE® and DESFire® systems, manufactured by NXP Semiconductors, but may be 125 kHz for lower frequency PROX® products, manufactured by HID Global Corp. This signal is received by an antenna 8 of the RFID device 2, comprising a tuned coil and capacitor, and then passed to an RFID chip 10. The received signal is rectified by a bridge rectifier 12, and DC power output by the rectifier 12 is used to power a control circuit 14.

A data output from the control circuit 14 is connected to a transistor 16, such as a field effect transistor, that is connected in parallel with the antenna 8. By switching on and off the transistor 16, a signal can be transmitted by the RFID device 2 and decoded by suitable control circuits 18 in the reader 4. This type of signalling is known as backscatter modulation or active load modulation, and is characterised by the fact that the reader 4 is used to power the return message to itself.

The control circuit 14 stores at least an identification number of the device 2 and typically comprises an integrated circuit for generating the modulated control signal. The control circuit 14 may optionally also include non-volatile memory, which may be read-only or re-writable, that stores additional data that can be transmitted by the same mechanism.

Some RFID devices 2 use RFID chips 10 having sophisticated encryption to protect the identification number or other private information stored on the chip 10, such as information about the owner of the device 2. These RFID chips 10 are commonly referred to as “secure chips”, or sometimes “payment chips”. However, many RFID devices 2 use simpler chips 10 having no encryption and that send their identification number to the reader 6 in the clear. Typically these devices will activate and begin broadcasting their identifier automatically upon harvesting sufficient power from an excitation field. Such devices 2 are commonly used in lower security applications, such as for tagging animals, user identification, access to buildings, or the like. The messages from these devices may be easily intercepted by an unauthorised third party.

In one exemplary situation, an access control card contains an identifier that, when presented, permits access to a secure area. The card does not use encryption and so is open to “sniffing” attacks (the name commonly applied to the unauthorised reading of the contents of the card). In a sniffing attack, an attacker approaches the holder of the card in a public location with a concealed RFID reader. When the reader is close to the RFID device, the RFID chip activates and the reader is able to read the contents of the RFID chip. With the identifier in the RFID chip revealed, the attacker is then able to create a copy of the access control card, which may then be used to gain unauthorized access to the secure area.

This shortcoming of the simple chips 10 has been widely reported in the media and has given rise to a public perception that more secure chips 10, of the type used in banking cards, have the same weakness.

### BRIEF SUMMARY

At least the preferred embodiments of the present invention seek to provide improved security for an RFID device to prevent sniffing attacks.

Viewed from a first aspect, the present invention provides an RFID device comprising an antenna; a passive RFID communication module configured to transmit data using the antenna to an RFID reader without the use of encryption; and a passive biometric authentication module configured to identify a user of the device, wherein the RFID device is configured such that both the passive RFID communication module and the passive biometric authentication module are powered by power harvested using the antenna, and wherein the passive RFID device is configured such that the passive RFID communication module is rendered inoperable by preventing sufficient power from the antenna reaching the passive RFID communication module until the passive biometric authentication module has verified the identity of the user.

The RFID device is less vulnerable to sniffing attacks of the type described previously because the device will hold its data securely until an authorized biometric identifier is presented to it. This is achieved by initially powering only the biometric authentication module, and keeping the communications module of the RFID device unpowered until a valid biometric identifier is presented, thus ensuring the device cannot be accessed without the knowledge and consent of the authorised user. Once enabled, the RFID communication module can transmit its identification number to a reader.

The present invention is particularly applicable to RFID devices of the type that do not use encryption because such devices are otherwise vulnerable to sniffing attacks, whereas encrypted RFID device have other means of protecting them from such attacks. That is to say, the data transmitted it sufficient to enable a clone of the RFID device to be made. The data may, for example, be an identifier (different to the biometric identifier) associated with the card or a user of the card, such as a numerical identifier.

RFID devices incorporating biometric protection are known, but such systems have previously used biometric verification in parallel with the transmission of data by the RFID communications module. Thus, such systems could still be sniffed because the card identifier is still transmitted, either before the biometric verification, or together with (either positive or negative) biometric verification information. In some systems, the biometric data is processed at the reader and so the RFID chip never receives an indication of whether the verification is successful. In the above device, however, the biometric data is authenticated in the biometric authentication module.

The RFID device is preferably an RFID access device. That is to say, the data is associated with a user that is permitted to access to an access-restricted area. Thus, if the RFID device is cloned, an unauthorised person could use the data to access the access-restricted area.

The biometric authentication module is preferably a fingerprint authentication module. The fingerprint authentication module preferably comprises a fingerprint scanner and a memory storing a reference fingerprint, the fingerprint authentication module verifying the identity of the user by comparing a fingerprint scanned by the fingerprint scanner with one stored in the memory. It will be appreciated that alternative forms of biometric verification may instead be used, such as EKG.

The RFID device may comprise a switch, wherein the RFID communication module is rendered operable or inoperable by actuation of the switch by the biometric authentication module.

The switch may be either in parallel with the antenna, such that closing the switch short-circuits the antenna and disables the RFID communication module, or in series with the RFID communication module such that opening the switch disables the RFID communication module.

Viewed from another aspect, the present invention provides a method of using an RFID device comprising an antenna, a passive RFID communication module and a passive biometric authentication module, the method comprising: presenting a biometric identifier to the RFID device; powering the passive biometric authentication module using power harvested by the antenna; verifying, by the passive biometric authentication module, the biometric identifier; when the biometric identifier is verified, enabling the passive RFID communication module by providing power from the antenna to the passive RFID communication module, wherein the RFID communication module is disabled until verification of the biometric identifier by the biometric authentication module; and communicating, by the enabled passive RFID communication module, data from the RFID device to an RFID reader in an unencrypted form, the passive RFID communication module being powered using the power harvested by the antenna.

Preferably, the method further comprises disabling the RFID communication module, for example after removal of the biometric identifier, after a predetermined time, or after communicating the data to the RFID reader.

The biometric identifier is preferably a fingerprint, thus the biometric authentication module may be a fingerprint authentication module.

The data communicated from the RFID device preferably includes at least an identifier of the RFID device or an identifier of a user of the RFID device. The identifier may be associated with a user permitted to access a restricted area. Thus, in accordance with this method, the identifier is never transmitted until the user has verified their identity to the device. Thus, the identifier cannot be “sniffed” in public areas, which might permit an unauthorised person to access the restricted area.

The enabling preferably comprises actuating a switch so as to provide power from an antenna of the RFID device to the RFID communication module.

The method preferably further comprises, in response to an attempt to access the data before the biometric identifier is verified, not providing the data because the RFID communication module is disabled.

### BRIEF DESCRIPTION OF THE DRAWINGS

Certain preferred embodiments of the present invention will now be described in greater detail, by way of example only and with reference to the accompanying Figures, in which:

FIG. 1 illustrates a circuit for a prior art passive RFID device; and

FIG. 2 illustrates a circuit for a passive RFID device incorporating a fingerprint scanner; and

FIG. 3 illustrates a smartcard incorporating the circuit of FIG. 2.

### DETAILED DESCRIPTION

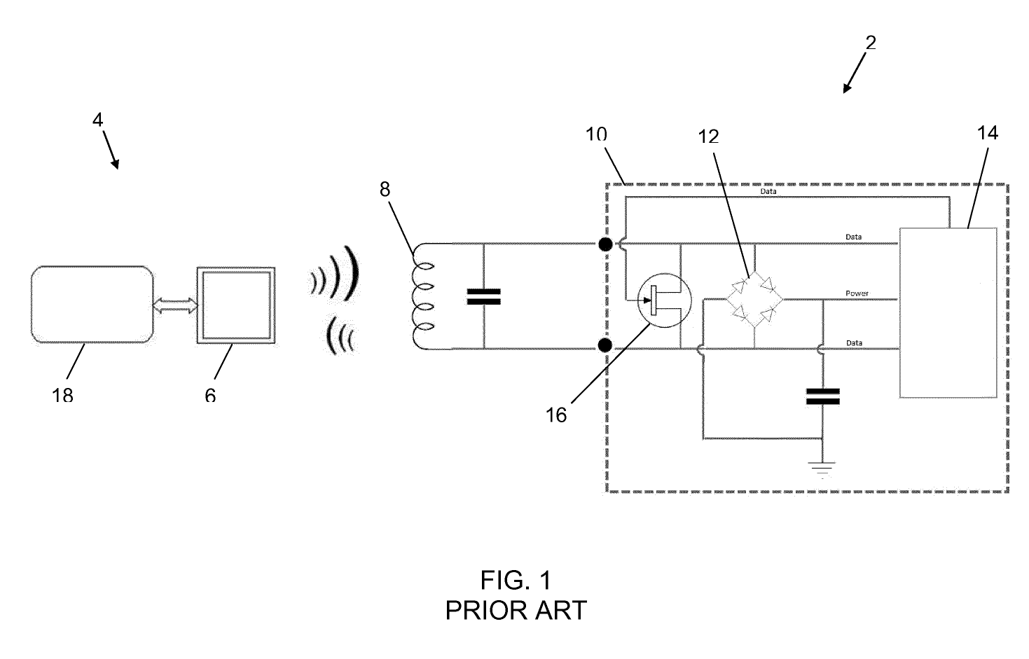

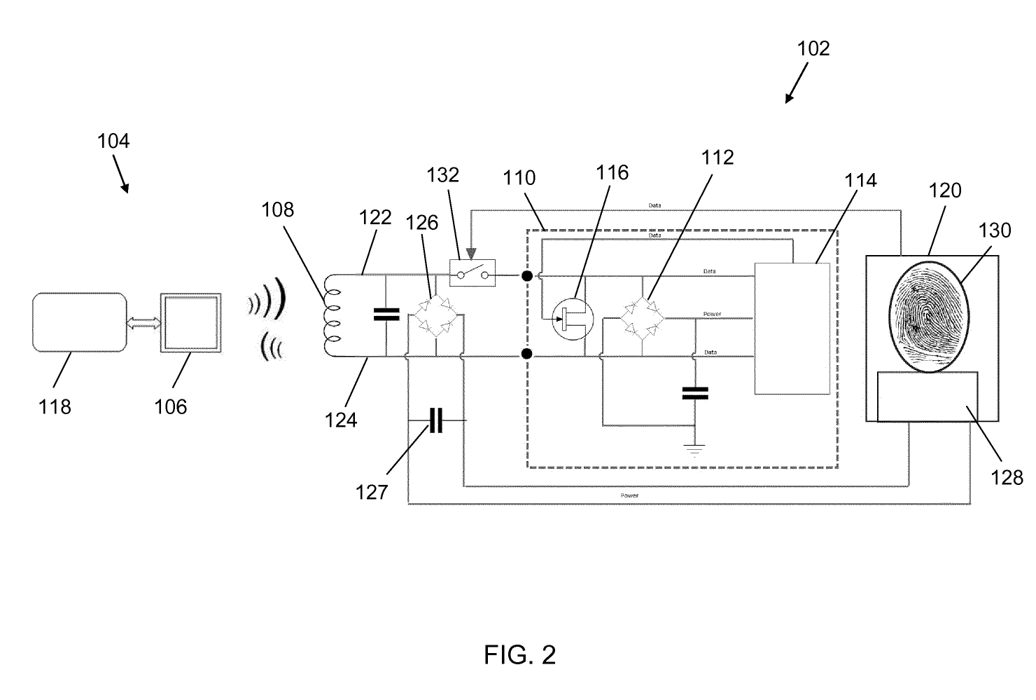

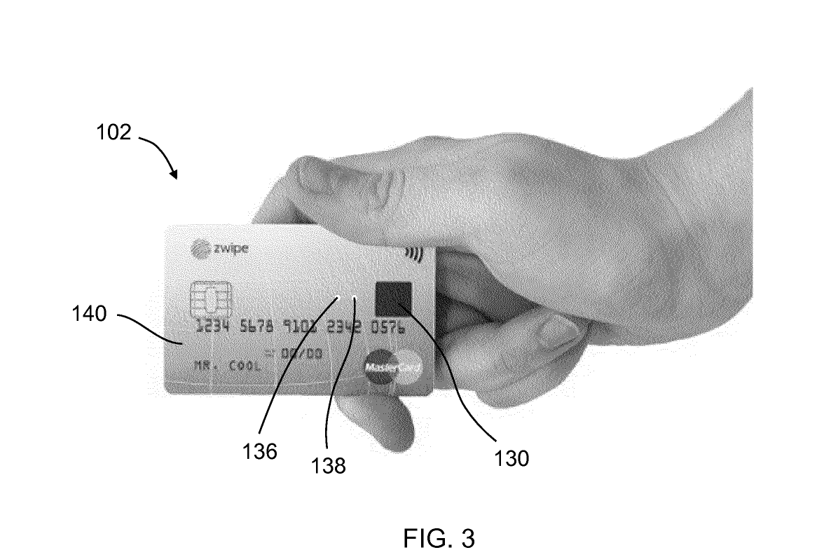

FIG. 2 shows the architecture of an RFID reader 104 and a passive RFID device 102, which is a variation of the prior art passive RFID device 2 shown in FIG. 1. The RFID device 102 shown in FIG. 2 has been adapted to include a fingerprint authentication engine 120 that disables the RFID chip 110 unless a valid fingerprint is presented. The passive RFID device 102 is preferably embodied as a laminated smartcard, such as illustrated in FIG. 3. The laminated body 140 encases all of the components of the circuit in FIG. 2. The body 140 has a width of 86 mm, a height of 54 mm and a thickness of 0.76 mm, although the thickness may be increased to accommodate the fingerprint authentication engine 120. More generally the RFID device 102 may comply with ISO 7816, which is the specification for a smartcard.

The RFID reader 104 is a conventional RFID reader and is configured to generate an RF excitation field using a reader antenna 106. The reader antenna 106 further receives incoming RF signals from the RFID device 102, which are decoded by control circuits 118 within the RFID reader 104.

The RFID device 102 comprises an antenna 108 for receiving an RF (radio-frequency) signal, a passive RFID chip 110 powered by the antenna, and a passive fingerprint authentication engine 120 powered by the antenna.

As used herein, the term “passive RFID device” should be understood to mean an RFID device 102 in which the RFID chip 110 is powered only by energy harvested from an RF excitation field, for example generated by the RFID reader 118. That is to say, a passive RFID device 102 relies on the RFID reader 118 to supply its power for broadcasting. A passive RFID device 102 would not normally include a battery, although a battery may be included to power auxiliary components of the circuit (but not to broadcast); such devices are often referred to as “semi-passive RFID devices”.

Similarly, the term “passive fingerprint/biometric authentication engine” should be understood to mean a fingerprint/biometric authentication engine that is powered only by energy harvested from an RF excitation field, for example an RF excitation field generated by the RFID reader 118.

The antenna 108 comprises a tuned circuit, in this arrangement including an induction coil and a capacitor, tuned to receive an RF signal from the RFID reader 104. When exposed to the excitation field generated by the RFID reader 104, a voltage is induced across the antenna 108.

The antenna 108 has first and second end output lines 122, 124, one at each end of the antenna 108. The output lines 122, 124 of the antenna 108 are connected to the fingerprint authentication engine 120 to provide power to the fingerprint authentication engine 120. In this arrangement, a rectifier 126 is provided to rectify the AC voltage received by the antenna 108. The DC rectified voltage is smoothed using a smoothing capacitor 127 and supplied to the fingerprint authentication engine 120.

Thus, the fingerprint authentication engine 120 in this embodiment is passive, and hence is powered only by the voltage output from the antenna 108.

The fingerprint authentication engine 120 includes a processing unit 128 and a fingerprint reader 130, which is preferably an area fingerprint reader 130. The fingerprint sensor 130 of the fingerprint authorisation engine 120, which can be an area fingerprint sensor 130, is fitted so as to be exposed from a laminated card body 140 as shown in FIG. 3. The processing unit 128 comprises a microprocessor that is chosen to be of very low power and very high speed, so as to be able to perform biometric matching in a reasonable time.

The fingerprint authentication engine 120 is arranged to scan a finger or thumb presented to the fingerprint reader 130 and to compare the scanned fingerprint of the finger or thumb to pre-stored fingerprint data using the processing unit 128. A determination is then made as to whether the scanned fingerprint matches the pre-stored fingerprint data. In a preferred embodiment, the time required for capturing a fingerprint image and accurately recognising an enrolled finger is less than one second. The card may provide an indication of successful authorisation using a suitable indicator, such as LEDs 136, 138 embedded within the card body 140.

If a match is determined, then the RFID chip 110 is enabled so as to transmit a signal to the RFID reader 104. In the FIG. 2 arrangement, this is achieved by closing a switch 132 located in series between the antenna 108 and the RFID chip 110 to connect the RFID chip 110 to the antenna 108. The fingerprint authentication engine 120 is configured to maintain the signal to the switch 132 to enable the RFID chip 110 fora predetermined time after verification of the fingerprint, for example 5 seconds after the fingerprint is verified. In alternative embodiments, the signal may only be maintained whilst the finger is actively being presented to the engine 120, i.e. removal of the finger immediately disables the RFID chip 110. In other embodiments, the device 102 may be configured such that the RFID chip 110 is kept enabled until it has finished communicating with the RFID reader 104.

The RFID chip 110 is conventional and operates in the same manner as the RFID chip 10 shown in FIG. 1 to broadcast a signal via the antenna 108 using backscatter, or active load, modulation by switch on and off a transistor 116. The RFID chip 110 includes a control circuit 114, comprising at least a microprocessor and a memory. The memory stores at least a unique identifier of the RFID device 102 or of a user of the RFID device 102.

In the present arrangement, the power for the RFID chip 110 and the fingerprint authentication engine 120 is harvested from the excitation field generated by the RFID reader 104. That is to say, the RFID device 102 is a passive RFID device, and thus has no battery, but instead uses power harvested from the reader 104 in a similar way to a basic RFID device 2.

The rectified output from second bridge rectifier 126 is used to power the fingerprint authentication engine 120. However, the power required for this is relatively high compared to the power demand for the components of a normal RFID device 2. Special design considerations may be required to draw sufficient energy from the RFID reader 104 to power some fingerprint readers 130 using power harvested from the excitation field of the RFID reader 104. A process for extracting high power from an RFID reader 104 is described in WO2016/055663.

Prior to use of the RFID device 102, the user of the device 102 must first enroll themself on the “virgin” device 102. After enrolment, the RFID device 102 will then be responsive to only this user. The RFID device 102, once enrolled may be used contactlessly, with no PIN, when the appropriate fingerprint is presented, or with only the PIN depending on the amount of the transaction taking place.

1. An RFID device comprising:
an antenna;
a passive RFID communication module configured to transmit data using the antenna to an RFID reader without the use of encryption; and
a passive biometric authentication module configured to identify a user of the device,
wherein the RFID device is configured such that both the passive RFID communication module and the passive biometric authentication module are powered by power harvested using the antenna, and
wherein the RFID device is configured such that the passive RFID communication module is rendered inoperable by preventing sufficient power from the antenna reaching the passive RFID communication module until the passive biometric authentication module has verified the identity of the user.

2. An RFID device according to claim 1, wherein the data includes an identifier associated with the RFID device or a user of the RFID device.

3. An RFID device according to claim 1, wherein the RFID device is an RFID access device to access to an access-restricted area.

4. An RFID device according to claim 1, wherein the passive biometric authentication module is a passive fingerprint authentication module.

5. An RFID device according to claim 1, wherein the passive RFID communication module is rendered operable or inoperable by actuation of a switch between the antenna and the passive RFID communication module.

6. An RFID device according to claim 1, wherein the passive RFID communication module is configured to automatically transmit the data responsive to receiving sufficient power.

7. A method of using an RFID device comprising an antenna, a passive RFID communication module and a passive biometric authentication module, the method comprising:
presenting a biometric identifier to the RFID device;
powering the passive biometric authentication module using power harvested by the antenna;
verifying, by the biometric authentication module, the biometric identifier;
when the biometric identifier is verified, enabling the passive RFID communication module by providing power from the antenna to the passive RFID communication module, wherein the RFID communication module is disabled until verification of the biometric identifier by the biometric authentication module; and
communicating, by the enabled passive RFID communication module, data from the RFID device to an RFID reader in an unencrypted form, the passive RFID communication module being powered using the power harvested by the antenna.

8. A method according to claim 7, further comprising:
disabling the passive RFID communication module, after removal of the biometric identifier, after a predetermined time, or after communicating the data to the RFID reader.

9. A method according to claim 7, wherein the biometric identifier is a fingerprint and the passive biometric authentication module is a passive fingerprint authentication module.

10. A method according to claim 7, wherein the data communicated from the RFID device includes at least an identifier of the RFID device or an identifier of a user of the RFID device.

11. A method according to claim 10, wherein the identifier is associated with a user permitted to access an access-restricted area.

12. A method according to claim 7, wherein the enabling comprises actuating a switch so as to provide power from the antenna to the passive RFID communication module.

13. A method according claim 7, further comprising:
in response to an attempt to access the data before the biometric identifier is presented or verified, not providing the data because the RFID communication module is disabled.
